(19) United States
(12) Patent Application Publication
(10) Pub. No.: US 2020/0127935 A1
(43) Pub. Date: Apr. 23, 2020

(54) SERVER AND RESOURCE ADJUSTMENT CONTROL METHOD

(71) Applicant: INDUSTRIAL TECHNOLOGY RESEARCH INSTITUTE, Hsinchu (TW)

(72) Inventors: Tsung-Sheng Cheng, Hsinchu (TW); Yi-Hung Lu, Hsinchu (TW); Kuen-Min Lee, Hsinchu (TW); Mu-Kai Huang, Hsinchu (TW); Wan-Ting Hong, Hsinchu (TW)

(21) Appl. No.: 16/232,177

(22) Filed: Dec. 26, 2018

(30) Foreign Application Priority Data
Oct. 17, 2018 (TW) 107136609

(51) Int. Cl. H04L 12/911; H04L 12/26; H04L 12/863

(52) U.S. Cl. CPC H04L 47/70; H04L 47/6245; H04L 43/08

(57) ABSTRACT

A resource adjusting and controlling method includes: monitoring, by a plurality of monitoring units of a server, one of a plurality of monitoring tags; monitoring usage statuses of the queues corresponding to the monitoring units, and determining if one of the monitoring units performs a queue space adjustment based on the usage statuses; adding the obtained new data to a corresponding one of the queues of the one of the monitoring units if the queue space adjustment is not performed; adjusting space of the one or more of the queues if the queue space adjustment is performed and one or more of the queues have a space that is adjustable; and reducing data stored in the corresponding one of the queues, if the queue space adjustment is performed and no space in the queues is adjustable.

### CROSS-REFERENCE TO RELATED APPLICATIONS

This application claims priority to Taiwanese Application Serial No. 107136609, filed on Oct. 17, 2018. The entirety of the above-mentioned patent application is hereby incorporated by reference herein and made a part of this specification.

### TECHNICAL FIELD

This disclosure relates to a server and application techniques thereof, and, more particularly, to a server with resource adjustment control and a resource adjustment control method.

### BACKGROUND

Considering more and more equipment connected to the Internet, how to deal with a large amount of data in the face of unexpected hardware resources in the case of limited hardware resources, resource allocation and data processing to reduce the extent of information distortion is becoming an important developing issue.

In addition, in the conventional OPC UA (OPC Unified Architecture) industrial transmission protocol, equipment data can be sampled and stored only the sampler (sampling), deadband filter and queue. The existing data overflow mechanism of the queue is FIFO (First-In-First-Out) or FILO (First-In-Last-Out) method, which is likely to cause blank of data in a certain period time and results in erroneous data determination.

Therefore, how to solve the above challenges has become one of the major research topics for those skilled in the art.

### SUMMARY

The present disclosure provides a server and a resource adjusting and controlling method that can regulate space or data of at least one queue.

In an embodiment of the present disclosure, a server comprises: a plurality of queues, each of which has its respective queue size; and one or more processors configured for executing a plurality of instructions to perform a resource adjusting and controlling process, including actuating: a plurality of monitoring units, each of which monitors one of a plurality of monitoring tags and corresponds to one of the plurality of queues, wherein each of the plurality of queues is configured for storing data of the plurality of monitoring tags and timestamps of the data; a resource monitoring device configured for monitoring usage statuses of the plurality of queues corresponding to the plurality of monitoring units and determining if one of the monitoring units performs a queue space adjustment based on the usage statuses when new data of the monitored monitoring tags is obtained, wherein the one of the monitoring units adds the obtained new data to a corresponding one of the plurality of queues if the queue space adjustment is not performed; a queue space adjuster is configured for determining whether there is a sufficient space for the queue space adjustment, wherein if the queue space adjustment is performed and one or more of the plurality of queues has a space that is adjustable, the space of the one or more of the queues is adjusted, to enable the obtained new data to be added to the adjusted one or more of the plurality of queues; and a data reducer is configured for reducing data stored in the corresponding one of the queues of the one of the monitoring units, if the queue space adjustment is performed and no space in the queues is adjustable, based on the timestamps of the data stored in the corresponding one of the queues and a position of the data stored in the corresponding one of the queues, to enable the obtained new data to be added to the corresponding one of the queues.

In another embodiment of the present disclosure, a resource adjusting and controlling method comprises: monitoring, by a plurality of monitoring units of a server, one of a plurality of monitoring tags, wherein each of the plurality of monitoring units corresponds to one of a plurality of queues, wherein each of the plurality of queues is used for storing data of the plurality of monitoring tags and timestamps of the data, and each of the plurality of queues has its respective queue size; monitoring, by the server, usage statuses of the plurality of queues corresponding to the plurality of monitoring units, and determining if one of the monitoring units performs a queue space adjustment based on the usage statuses when new data of the monitored monitoring tags is obtained; adding the obtained new data to a corresponding one of the queues of the one of the monitoring units by the server if the queue space adjustment is not performed; adjusting space of the one or more of the plurality of queues if the queue space adjustment is performed and one or more of the plurality of queues have a space that is adjustable, to enable the obtained new data to be added to the adjusted one or more of the plurality of queues; and reducing the data of the corresponding one of the queues of the one of the monitoring units, if the queue space adjustment is performed and no space in the queues is adjustable, based on the timestamps of the data stored in the corresponding one of the queues and a position of the data stored in the corresponding one of the queues o, to enable the obtained new data to be added to the corresponding one of the queues.

### BRIEF DESCRIPTION OF DRAWINGS

The disclosure can be more fully understood by reading the following detailed description of the embodiments, with reference made to the accompanying drawings, wherein:

FIG. 1 is an architectural schematic diagram of a server according to an embodiment of the present disclosure;

FIG. 2A is a flow chart of a resource adjusting and controlling method according to an embodiment of the present disclosure;

FIG. 2B is a flow chart of a queue space adjusting algorithm of queue space adjuster according to an embodiment of the present disclosure;

FIG. 3 is an architectural schematic diagram of a monitoring unit and a monitoring tag according to an embodiment of the present disclosure;

FIG. 4 is a flow chart of a queue space adjustment algorithm of a queue space adjuster according to another embodiment of the present disclosure;

FIG. 5A is a schematic diagram of a queue space adjustment algorithm applied to a monitoring unit according to an embodiment of the present disclosure;

FIG. 5B is a schematic diagram of a queue space adjustment algorithm applied to a monitoring unit according to another embodiment of the present disclosure;

FIG. 6 is a flow chart of a data reduction algorithm of a data reducer according to an embodiment of the present disclosure;

FIGS. 7A and 7B are schematic diagrams of data of queues according to different embodiments of the present disclosure, used for operation with the data reduction algorithm of FIG. 6;

FIG. 8 is a schematic diagram of data of a first-type reduced queue by a data reduction algorithm according to an embodiment of the present disclosure;

FIG. 9 and FIG. 10A to FIG. 10C are schematic diagrams of data of a second-type reduced queue by a data reduction algorithm according to an embodiment of the present disclosure;

FIG. 11 is a flow chart of a data restoring algorithm of a data restorer according to an embodiment of the present disclosure;

FIG. 12 is a schematic diagram of data of a queue according to an embodiment of the present disclosure, used for operation with the data restoring algorithm of FIG. 11;

FIG. 13A to FIG. 13C are schematic diagrams of a data restoring algorithm restoring data of a queue according to an embodiment of the present disclosure;

FIG. 14 is a schematic diagram of the best circumstance of data of a queue according to the present disclosure;

FIG. 15A is a schematic diagram of a result of a state that data is not lost;

FIG. 15B is a schematic diagram of a result of a resource adjusting and controlling method according to the prior art; and

FIG. 15C is a schematic diagram of a result of a server and a resource adjusting and controlling method according to the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

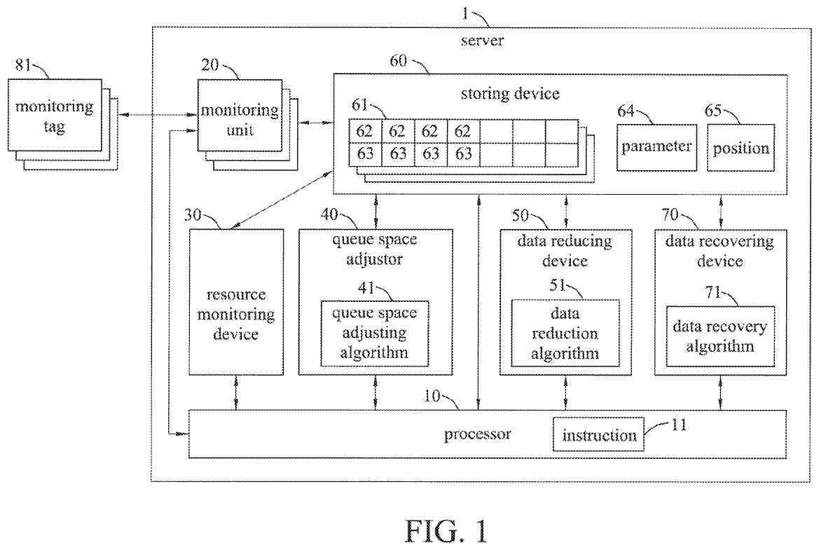

FIG. 1 is an architectural schematic diagram of a server 1 according to an embodiment of the present disclosure. The server 1 may include one or more processors 10, a plurality of monitoring units (MUs) 20, a resource monitoring device 30, a queue space adjuster 40, a data reducer 50, and a storing device 60 that has a plurality of queues 61. In another embodiment of the present disclosure, the server 1 further includes a data restorer 70. In an embodiment of the present disclosure, the processor 10 (such as a central processor, multiple processors, a microprocessor, etc., but not limited to these) and the storing device 60 (such as any memory or storage devices) are hardware, the monitoring units 20, the resource monitoring device 30, the queue space adjuster 40, the data reducer 50 or the data restorer 70 can be any hardware IC, programmable ASIC, programmable logic array, and/or firmware, software, etc. (but not limited to these) that can be executed by a processor.

The server 1 can be applied to a system having a plurality of monitoring units 20, each of which is used for monitoring a monitoring tag 81. Data of the monitoring tags can be transmitted based on a transmission protocol that conforms to the industry transmission network. The processor 10 can execute a plurality of instructions 11 to perform a resource regulation of each corresponding one of the queues 61 of the one of the monitoring units 20, including actuating the monitoring units 20, the resource monitoring device 30, the queue space adjuster 40 and the data reducer 50 to perform a resource adjusting and controlling process. The queues 61 are used for storing data 62 obtained from the monitoring tags 81 and timestamps 63 of the data 62. The storing device 60 further stores a plurality of instructions 11 executed by the processor 10, variables (e.g., a position 65 of the queue), the corresponding one of the queues 61 of the one of the monitoring units 20, and parameters 64, such as a sampling frequency, a queue size and an issuing time.

The timestamp 63 refers to a sequence of data added by identification words (such as time or date), to ensure that the data updating orders of the local and remote ends are consistent. The timestamp recorded and commonly used on computers is POSIX time, which is a time representation used by UNIX systems. It can record the total number of seconds from 0:00:00 GMT on Jan. 1, 1970 till now, excluding leap seconds. For instance, 2018-06-62 15:30:20 GMT+8, POSIX timestamp can be 1529652620. However, as long as the timestamp 63 can distinguish the time representation of the order, the method of recording is not limited.

The queues 61 have respective queue sizes. Each of the monitoring units 20 monitors one of the monitoring tags 81 (that is, each of the monitoring units 20 monitoring one monitoring tag 81), to transmit the data obtained from the monitoring tags 81. In an embodiment of the present disclosure, the monitoring tags 81 may be a thermometer, a voltmeter, an ammeter, a vibrator, an acoustic sensor, etc., but not limited to these. The monitoring units 20 can be electrically connected to the monitoring tags 81 in a wired or wireless manner to acquire (obtain or receive) the data of the monitoring tags 81. Each of the monitoring units 20 may correspond to a corresponding one of the queues 61. Each of the queues 61 is used for storing the data 62 of the monitoring tags 81 and the timestamps 63 of the data 62.

The resource monitoring device 30 may monitor the usage statuses of the corresponding one of the queues 61 of the one of the monitoring units 20, in order to determine if one of the monitoring units 20 performs a queue space adjustment based on the usage statuses of the corresponding one of the queues 61 when new data of the monitoring tags 81 is obtained. If the resource monitoring device 30 determines that the queue space adjustment is not performed, the one of the monitoring units 20 adds the obtained new data into the corresponding one of the queues 61 of the any monitoring unit 20.

When the resource monitoring device 30 determines that the queue space adjustment is performed, the queue space adjuster 40 will be actuated. The queue space adjuster 40 is used for determining whether there is a space sufficient to perform the queue space adjustment. When the queue space adjustment is performed and one or more queues in the queues 61 have an adjustable space, the obtained new data can be added to the adjusted one or more queues in the plurality of queues 61. When the queue space adjustment is performed and the queues 61 do not have any adjustable space, the resource monitoring device 30 actuates the data reducer 50, and reduces the data 62 stored in the corresponding one of the queues 61 of the one of the monitoring units 20 based on the timestamps 63 of each data 62 stored in the corresponding one of the queues 61 of the one of the monitoring units 20 and a position of each data 62 in the corresponding one of the queues 61 of the one of the monitoring units 20, so that the obtained new data is added to the corresponding one of the queues 61 of the one of the monitoring units 20.

In an embodiment of the present disclosure, the data restorer 70 further included in the server 1 has a data restoring algorithm 71 to restore the data 62 of the corresponding one of the queues 61 of the one of the monitoring units 20. The data restoring algorithm 71 acquires the data 62 of the corresponding one of the queues 61 from the data restorer 70. When the data 62 of the corresponding one of the queues 61 have been sorted based on their respective timestamps 63, the data 62 of the corresponding one of the queues 61 are determined to be restored or do not need to be restored, and a further process is not needed. When the data 62 of the corresponding one of the queues 61 are not sorted based on their respective timestamps 63, the data restorer 70 restores the data 62 of the corresponding one of the queues 61 based on the timestamps 63 of the data of the corresponding one of the queues 61 and the relative sorting position of the data 62 in the corresponding one of the queues 61.

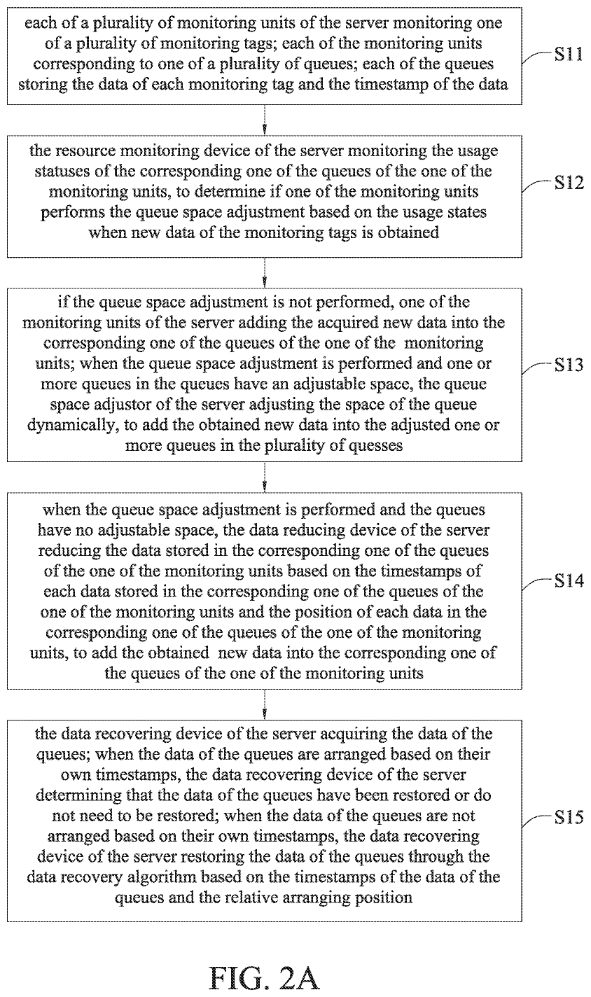

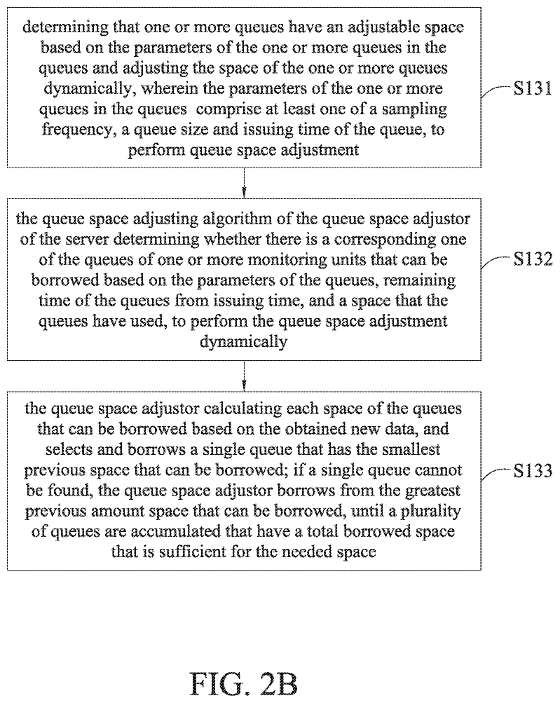

FIG. 2A is a flow chart of a resource adjusting and controlling method according to an embodiment of the present disclosure. The primary technical contents of the method are disclosed in the following paragraphs, while the remaining technical contents can be referred to FIG. 1 or FIG. 3 to FIG. 13C, and will not be repeated hereby.

In step S11 of the embodiment of FIG. 2A, each of a plurality of monitoring units 20 of the server 1 monitors one of a plurality of monitoring tags 81. Each of the monitoring units 20 corresponds to one of a plurality of queues 61. Each of the queues 61 stores the data 62 of each monitoring tag 81 and the timestamp 63 of the data 62. The queues 61 have their respective queue sizes. When new data of the monitoring tags 81 are obtained, the monitoring units 20 is responsible for adding the new data to the queues 61.

In step S12 of the embodiment of FIG. 2A, the resource monitoring device 30 of the server 1 monitors the usage statuses of the corresponding one of the queues 61 of the one of the monitoring units 20, in order to determine if one of the monitoring units 20 performs the queue space adjustment based on the usage states when new data of the monitored monitoring tags 81 is obtained.

In step S13 of the embodiment of FIG. 2A, if the queue space adjustment is not performed, one of the monitoring units 20 of the server 1 adds the acquired new data to the corresponding one of the queues 61 of the one of the monitoring units 20. When the queue space adjustment is performed and one or more queues in the queues 61 have an adjustable space, the queue space adjuster 40 of the server 1 adjusts the space of the queue dynamically, so that the obtained new data is added to the adjusted one or more queues in the plurality of queues 61.

In step S14 of the embodiment of FIG. 2A, when the queue space adjustment is performed and the queues 61 have no adjustable space, the data reducer 50 of the server 1 reduces the data 62 stored in the corresponding one of the queues 61 of the one of the monitoring units 20 based on the timestamps 63 of each data 62 stored in the corresponding one of the queues 61 of the one of the monitoring units 20 and the position 65 of each data 62 in the corresponding one of the queues 61 of the one of the monitoring units 20, so that the obtained new data is added to the corresponding one of the queues 61 of the one of the monitoring units 20.

This embodiment can be further executed in step S15, in which the data restorer 70 of the server 1 acquires the data 62 of the queues 61. When the data 62 of the queues 61 are sorted based on their respective timestamps 63, the data restorer 70 of the server 1 determines that the data 62 of the queues 61 have been restored or do not need to be restored. When the data 62 of the queues 61 are not sorted based on their respective timestamps 63, the data restorer 70 of the server 1 restores the data 62 of the queues 61 through the data restoring algorithm 71 based on the timestamps 63 of the data 62 of the queues 61 and the relative sorting position 65.

Refer to FIG. 1 and FIG. 2B. FIG. 2B is a flow chart of a queue space adjusting algorithm of a queue space adjuster according to an embodiment of the present disclosure. In an embodiment of the present disclosure, the queue space adjuster 40 of the server 1 may operate a queue space adjusting algorithm 41, which includes, as shown in step S131 of FIG. 2B: determining that one or more queues have an adjustable space based on the parameters 64 of the one or more queues in the queues 61 and adjusting the space of the one or more queues dynamically, wherein the parameters 64 of the one or more queues in the queues 61 include at least one of a sampling frequency, a queue size and an issuing time of the queue 61, to perform a queue space adjustment. In another embodiment of the present disclosure, as shown in step S132 of FIG. 2B, the queue space adjusting algorithm 41 of the queue space adjuster 40 of the server 1 determines whether there is a corresponding one of the queues 61 of one or more monitoring units 20 that can be borrowed based on the parameters 64 of the queues 61, remaining time of the queues 61 from the issuing time, and a space that the queues 61 have used, to perform the queue space adjustment dynamically. In yet another embodiment of the present disclosure, as shown in step S133 of FIG. 2B, the queue space adjuster 40 calculates each borrowable space of the queues 61 based on the obtained new data, and selects and borrows a single queue 61 having the smallest previous space that can be borrowed. If a single queue 61 cannot be found, the queue space adjuster 40 starts to borrow from the queue that has the largest previous amount of the borrowable space until an accumulated space of the plurality of queues 61 is borrowed space to a sufficient space.

Refer to FIG. 1 and FIG. 2A. In an embodiment of the present disclosure, the data reducer 50 of the server 1 has a data reduction algorithm 51 to reduce the data 62 of the corresponding one of the queues 61 of the one of the monitoring units. For instance, the data reduction algorithm 51 of the data reducer 50 includes: the data reducer 50 acquiring a pair of data with the smallest difference in the space corresponding to the corresponding one of the queues 61 of the one of the monitoring units that needs to be adjusted; and when the pair of data is adjacent in the corresponding one of the queues 61 of the one of the monitoring units, the data reducer 50 removes one of the pair of data with a larger timestamp in the pair of data from the corresponding one of the queues 61 of the one of the monitoring units, to move all the data except the position of the removed data forward by one queue position and store the obtained new data of the one of the monitoring units in the queue position behind all the data in the corresponding one of the queues 61 of the one of the monitoring units; and when the pair of data is not adjacent in the queue 61 and the timestamp of the data in which the timestamp is smaller than the one of the pair of data is greater than and closest to the one of the pair of data with the smaller timestamp, the data reducer 50 removes the one of the pair of data with the larger timestamp, moves all the data in the middle of the pair of data back one queue position, and stores the obtained new data of the any monitoring unit in the queue position where the data is removed, or the data reducer 50 removes the one of the pair of data with the smaller timestamp.

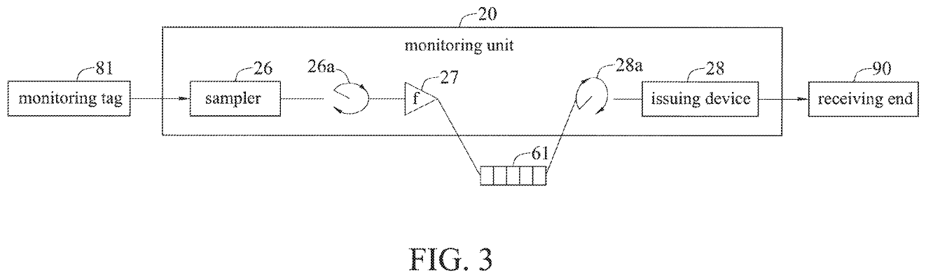

FIG. 3 is an architectural schematic diagram of a monitoring unit 20 and a monitoring tag 81 according to an embodiment of the present disclosure. Refer to FIG. 3 and FIG. 1. The server 1 may include a plurality of monitoring units 20 to monitor a plurality of monitoring tags 81, respectively, such as a thermometer, a voltmeter, an ammeter, a vibrator, an acoustic sensor, etc., but not limited to these. Each of the monitoring units 20 is assigned to a queue 61 that stores data of each of the monitoring tags 81 temporarily, and has a sampler 26 setting a sampling frequency 26a, a filter 27 (such as a blind band filter) setting a threshold, and an issuing device 28 setting an issuing time 28a. For instance, the sampler 26 sets the sampling frequency 26a to determine how long the value of the data of the monitoring tags 81 will be read once, the filter 27 sets the threshold to determine whether the data obtained every time will be recorded in the queue 61, and the issuing device 28 sets the issuing time 28a to determine how long the data of the queue 61 will be issued to the receiving end 90 and the data of the queue 61 will be cleared.

For instance, the sampling frequency 26a of the sampler 26 is set to be one second, the threshold of the filter 27 is set to be five, the issuing time 28a of the issuing device 28 is set to be five seconds, and the space of the queue 61 is set to be five, so that the monitoring unit 20 monitors the monitoring tags 81 once a second (the sampling frequency 26a), if a difference between the value of the data of the monitoring tags 81 and the value of the data recorded last time exceeds the threshold that is five, the value of the data of the monitoring tags 81 will be added to the queue 61, or the value of the data of the monitoring tags 81 will not be recorded (less than the threshold that is five), and the monitoring unit 20 will issue all data of the queue 61 to the receiving end 90 (such as another server) every five seconds (the issuing time 28a), and further clears the data of the queue 61, which are repeated continuously.

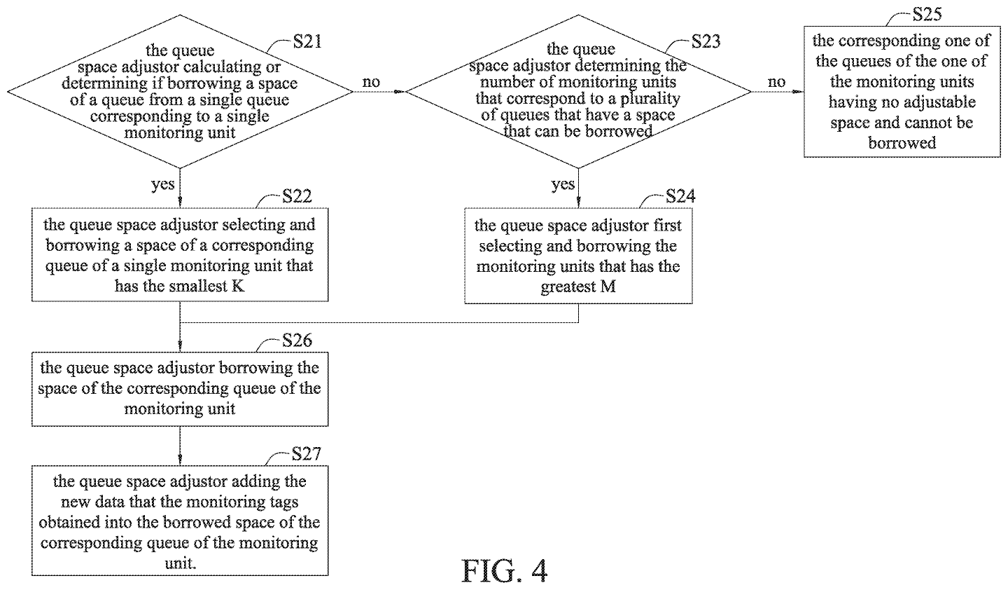

FIG. 4 is a flow chart of a queue space adjustment algorithm of a queue space adjuster according to another embodiment of the present disclosure. In an embodiment, the queue space adjuster calculates a space of each borrowable queue in the queues based on the amount of new data, and selects and borrows a single queue with the smallest amount of the borrowed space; if the single queue cannot be found, the queue space adjuster borrows a space from a plurality of queues.

For instance, in step S21 the queue space adjuster calculates or determines if a space of a queue is borrowed from a single queue corresponding to a single monitoring unit. If so (can borrow a space of a queue from the corresponding queue of the single monitoring unit), proceed to step S22, in which the queue space adjuster selects and borrows a space of a corresponding queue (a single queue) of a single monitoring unit with the smallest K (i.e., having the smallest amount of borrowed space), wherein K represents the amount of the borrowed space of the corresponding queue of the single monitoring unit; if not (cannot borrow the space of the corresponding queue of the single monitoring unit), proceed to step S23.

In step S23, the queue space adjuster determines the number of monitoring units that correspond to a plurality of queues that have borrowable space. If the amount of the borrowable space of the monitoring units is greater than a demand space, then borrowing the space of the queues corresponding to the monitoring units, and step S24 is executed, in which the queue space adjuster first selects and borrows the monitoring units with the greatest M (i.e., having the greatest amount of space that can be borrowed), wherein M represents the amount of the borrowable space of each queue of the monitoring units. If the borrowable space of all monitoring units is insufficient to store the excess data amount, step S25 is executed, the corresponding one of the queues of the one of the monitoring units have no adjustable space and cannot be borrowed. In another embodiment of the present disclosure, if a single queue 61 cannot be found, the queue space adjuster 40 borrows a space first from the previous borrowable space with the greatest amount, until the borrowable spaces of a plurality of queues 61 are accumulated and are enough for the needed space.

Following step S22 or step S24, in step S26 the queue space adjuster borrows the space of the corresponding queue of the monitoring unit. In step S27, the queue space adjuster adds the new data that obtained by the monitoring tags to the borrowable space of the corresponding queue of the monitoring unit.

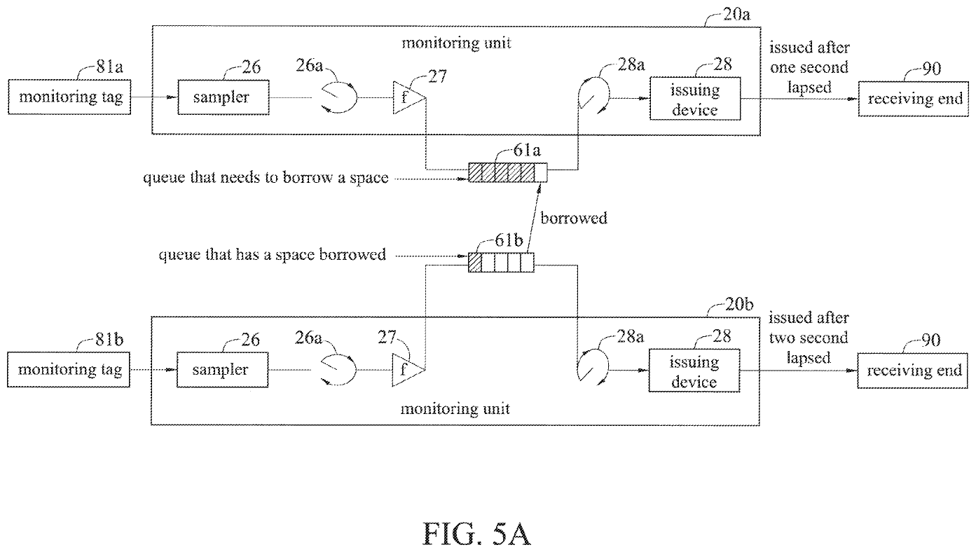

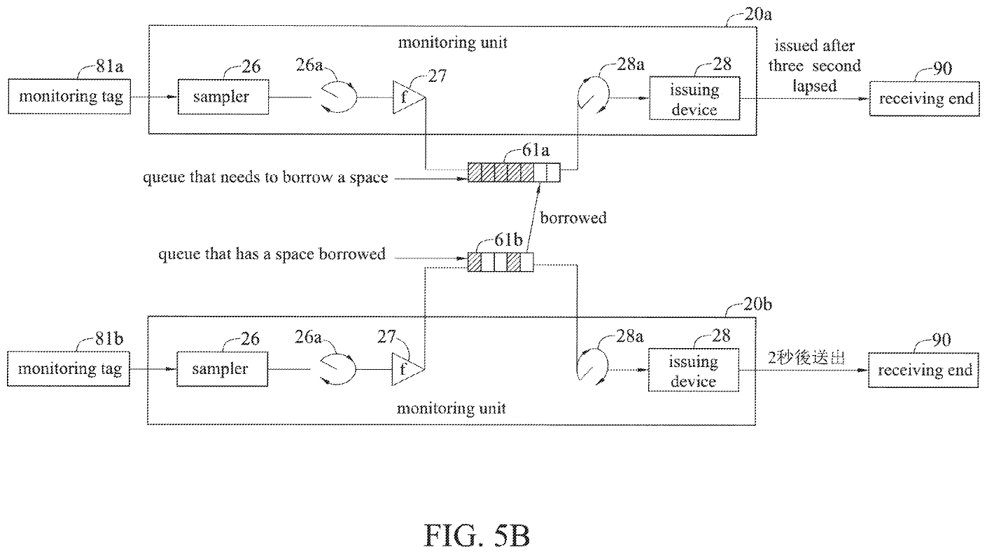

FIG. 5A is a schematic diagram of a queue space adjustment algorithm applied to a monitoring unit according to an embodiment of the present disclosure, showing the space of a queue borrowed from a single monitoring unit and a scenario that “remaining time of the completely filled queue from the issuing time” is less than “remaining time of the borrowed queue from the issuing time.”

For instance, the monitoring unit 20a monitors the monitoring tags 81a and the monitoring unit 20b monitors the monitoring tags 81b. Assuming that the space of the corresponding queue 61a of the monitoring unit 20a is insufficient to accommodate the obtained data, the queue space adjuster 40 actuates the queue dynamic adjustment mechanism (i.e., the queue space adjustment algorithm) and finds “four spaces” having space in the queue 61b of the monitoring unit 20b, the monitoring unit 20b will issue data and empty the queue 61b after 2 seconds, the queue 61a will only add up to 2 more pieces of data, and the monitoring unit 20a will issue data after one second and need to borrow “one space” only. The previously-described two spaces added by the one space is less than the four spaces (i.e., 2+1<4), and the monitoring unit 20a can borrow the space of the queue 61b from the single monitoring unit 20b.

FIG. 5B is a schematic diagram of a queue space adjustment algorithm applied to a monitoring unit according to another embodiment of the present disclosure, showing the space of the queue borrowed from a single monitoring unit and an scenario that “remaining time of the completely filled queue from the issuing time” is greater than “remaining time of the borrowed queue from the issuing time.”

For instance, in an embodiment the monitoring unit 20a monitors the monitoring tags 81a and the monitoring unit 20b monitors the monitoring tags 81b. Assuming that the space of the corresponding queue 61a of the monitoring unit 20a is insufficient to accommodate the obtained data, and the queue space adjuster 40 actuates the queue dynamic adjustment mechanism (i.e., the queue space adjustment algorithm) and finds “four spaces” having space in the queue 61b of the monitoring unit 20b after 2 seconds, the monitoring unit 20b will issue data and empty the queue 61b after 2 seconds, and the queue 61b will only add up to 2 more pieces of data. Although the monitoring unit 20a will not issue data after 3 seconds and need to borrow “three spaces,” the monitoring unit 20b will empty the queue 61b after 2 seconds. Then, the monitoring unit 20b can lend “two spaces” of the queue 61b to the monitoring unit 20a, and the monitoring unit 20b uses “two spaces” of the queue 61b. Two spaces added by two spaces is less than or equal to four spaces (2+2<=4). The monitoring unit 20b has emptied the queue 61b after 3 seconds. Before the monitoring unit 20a issues the data of the queue 61a, the monitoring unit 20b only needs to add data to “one space” of the queue 61b. The previously-described one space added by three spaces is less than five spaces of the queue 61b (i.e., 1+3<5). Therefore, the monitoring unit 20a can borrow the space of the queue 61b from the single monitoring unit 20b.

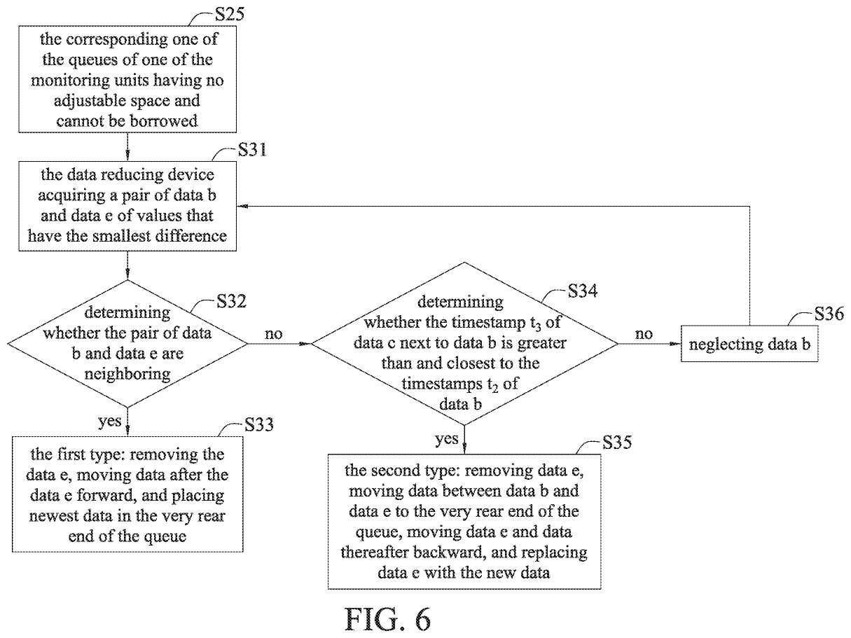

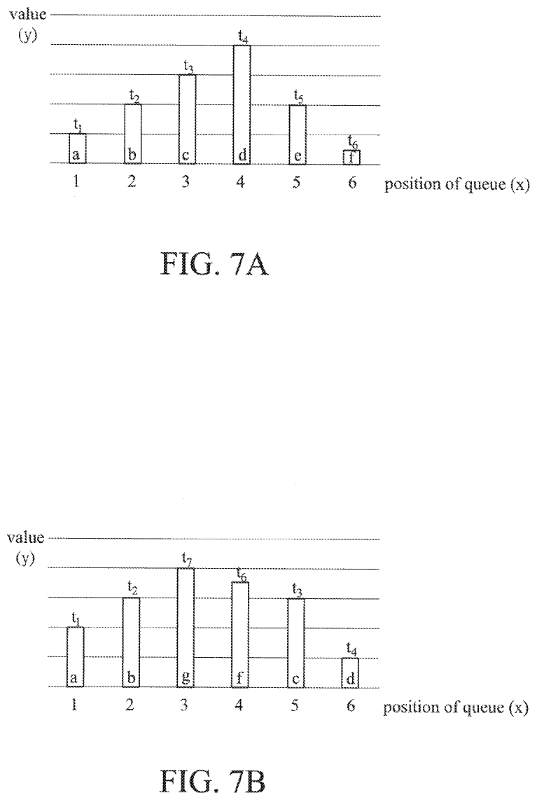

FIG. 6 is a flow chart of a data reduction algorithm of a data reducer 50 according to the present disclosure. FIGS. 7A and 7B are schematic diagrams of the data of queues according to different embodiments of the present disclosure, and applied to the data reduction algorithm of FIG. 6. In FIG. 7A and FIG. 7B, the six pieces of data a-f of the single queue have different timestamps t₁-t₆ sorted in a time sequence from small to large.

As shown in FIG. 6 and step S25 of FIG. 4, the corresponding one of the queues of one of a plurality of monitoring units have no adjustable space and cannot be borrowed. In an embodiment, referring to step S31 to step S36 of FIG. 6, the data reduction algorithm of the data reducer 50 reduces and acquires data of the corresponding queue of a monitoring unit of new data.

In step S31, the data reducer acquires a pair of data with the smallest difference in the values y, such as a pair of data b and data e shown in FIG. 7A (a difference between the two values y is zero). In step S32, the data reducer determines whether the pair of data b and data e are adjacent each other. If so, (the data b is adjacent to data e), proceed to step S33, or (the pair of data b and data e are not adjacent), proceed to step S34.

In the first-type of the data reduction algorithm of step S33, when the pair of data b and data e are adjacent, the data reducer removes the data e, moves data after the data e forward, and places latest data at the last end of the queue.

In step S34, when the pair of data b and data e are not adjacent, the data reducer determines whether the timestamp t₃ of the data c after data b is greater than and closest to the timestamps t₂ of the data b. If so (for example, in FIG. 7A, the timestamps t₃ of the data c after data b is greater than and closest to the timestamps t₂ of the data b), proceed to the second-type of the data reduction algorithm of step S35, in which the data reducer removes the data e, moves the data between the data b and the data e to the last end of the queue, moves the data e and subsequent data forward, and replaces the data e with the new data. If not, proceed to step S36, neglect the data b by the data reducer, and return to step S31.

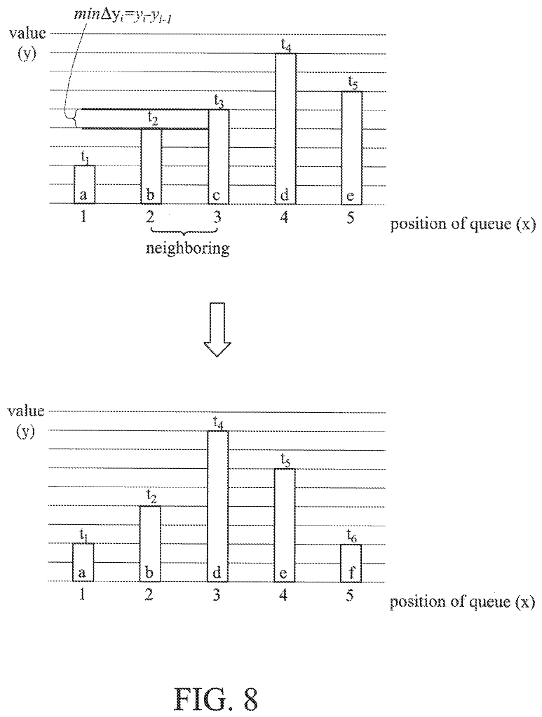

FIG. 8 is a schematic diagram of data of a first-type reduced queue by a data reduction algorithm according to an embodiment of the present disclosure. As shown in the drawings, when the data is reversed, the data reducer finds the numerical difference (e.g., Δy) in the values of any two data. The smallest numerical difference between the two data can be calculated by a formula minΔyᵢ=yᵢ−yᵢ₋₁, where y is a value of the data and i is a positive integer. When the two data (e.g., data b and data c) with the smallest difference are adjacent, the data reducer removes the latter of the two data (e.g., data c), moves all data after the data c (e.g., data d and data e) forward by one queue position, and adds new data (e.g., data f) to the last end of the queue (other data).

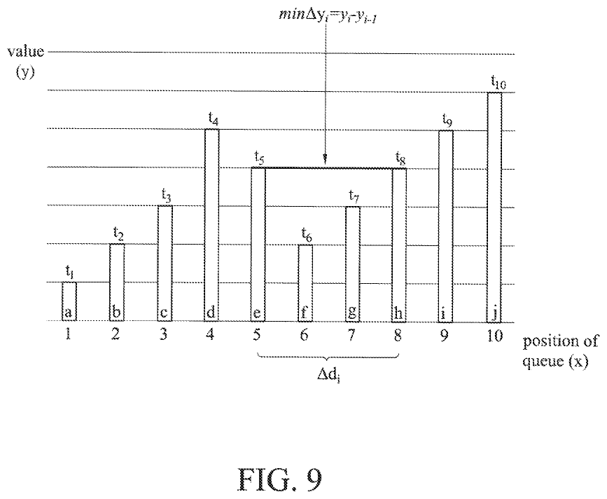

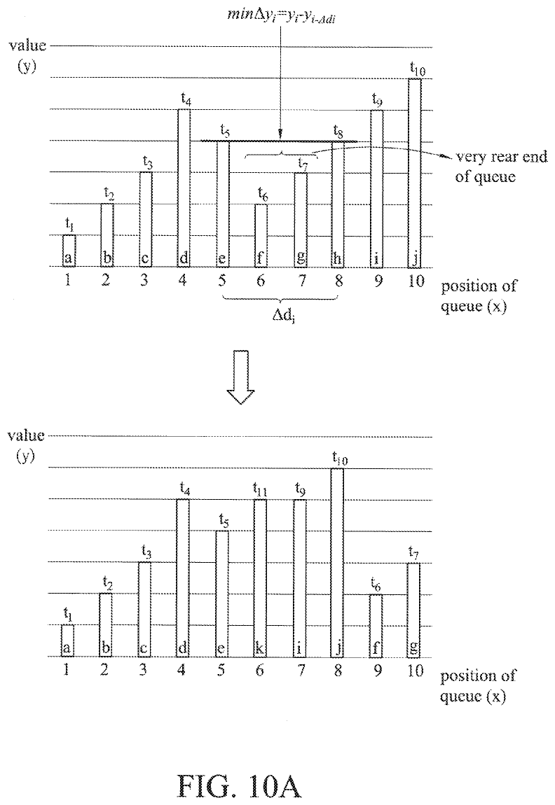

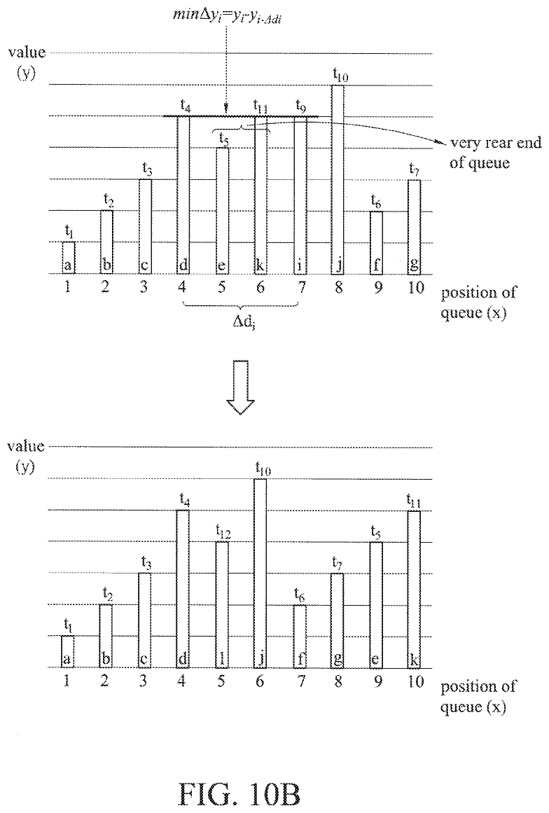

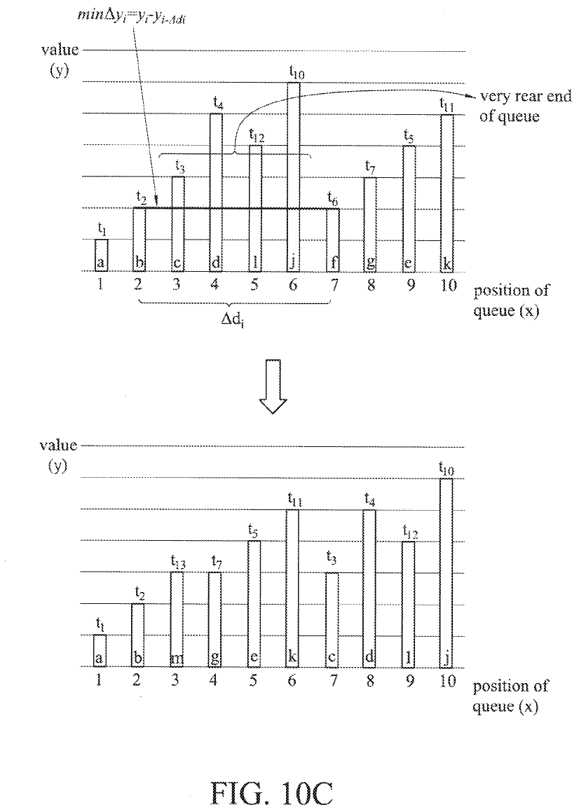

FIG. 9 and FIG. 10A to FIG. 10C are schematic diagrams of data of a second-type reduced queue by a data reduction algorithm according to an embodiment of the present disclosure. In FIG. 9, ten pieces of data a-j of a single queue 10 have ten different timestamps t₁-t₁₀, and the timestamps t₁-t₁₀ represent a time sequence from small to large.

As shown in the embodiment of FIG. 9, when data is reversed, the data reducer finds a numerical difference Δyᵢ and a distance difference Δdᵢ of any two data, where Δdᵢ is a difference of two data in the positions x of the queue (a position serial number difference). When a pair of data with the smallest numerical difference Δyᵢ (e.g., data e and data h) are not adjacent, and the timestamp t₆ of the data after the data e is greater than or closest to the timestamp t₅ of the data e, the data reducer moves all data between the pair of data e and h (e.g., data f and data g) to the last end of the queue, and replaces the data h with the new data (i.e., after the data is deleted, the new data will be placed at the data h).

In addition, the numerical difference Δyᵢ of two data is the same, the minimum distance difference Δdᵢ of the two data is taken as the replacement target and replaced by the new data. Moreover, the numerical difference Δyᵢ of the two data is the same as the distance difference Δdᵢ, the one that has the former serial number will be replaced by the new data.

As shown in the embodiment of FIG. 10A, the data reducer acquires the data e, f, g and h as the processing targets, and moves the data f and the data g between the data e and the data h to the last end of the queue. The data i and the data j following the data h are moved forward to the back of the data e, the data h is replaced by the new data (the 11^{th} data), and the new data k is no longer involved in the comparison. As shown in FIG. 10B, the data reducer then adds the new data (the 12^{th} data), and repeats the procedure of FIG. 10A, and the new data l is no longer involved in the comparison. Moreover, as shown in FIG. 10C, the data reducer adds the new data m (the 13^{th} data), repeats the procedure of FIG. 10B, and the new data m is no longer in the comparison.

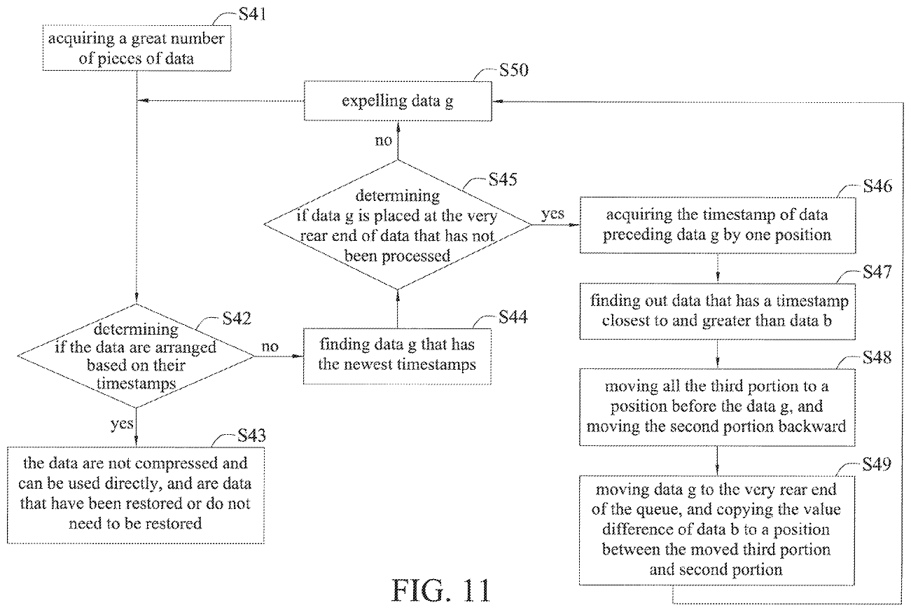

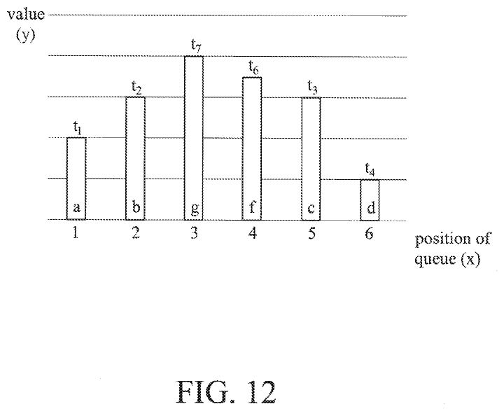

FIG. 11 is a flow chart of a data restoring algorithm of a data restorer 70 according to an embodiment of the present disclosure. FIG. 12 is a schematic diagram of data of a queue according to an embodiment of the present disclosure, used for operation with the data restoring algorithm of FIG. 11;

As shown in the embodiments of FIG. 11 and FIG. 12, in step S41, the data restorer acquires multiple data.

In step S42, it is determined by the data restorer whether the data has been sorted based on the timestamps. If so (the data have been sorted based on the timestamps), proceed to step S43, which indicates that the data can be directly used without being compressed, that is, the data are restored or not required to be restored. If not (the data are not sorted based on the timestamps), proceed to step S44, in which the data restorer finds latest data (e.g., the data g) of the timestamps (e.g., timestamp t7).

In step S45, the data restorer determines if the data g is placed at the last end of the unprocessed data. If so (data g is not placed at the last end of the unprocessed data), proceed to step S46. If not (the data g is placed at the last end of the unprocessed data), proceed to step S50 to exclude the data g.

In step S46, the data restorer divides the data into four portions (data g, a first portion, a second portion and a third portion), and the data restorer acquires the timestamp of the data of the previous position of the data g (e.g., the data b, and the data before the data b is the first portion). In step S47, the data restorer finds the data with a timestamp closest to and greater than the data b (e.g., the data c, the data between the data b and the data c is the second portion, and the data c and the subsequent data are the third portion). In step S48, the data restorer moves all the third portion to the front of the data g, and moves the second portion backward. In step S49, the data restorer moves the data g to the last end of the queue, and enters the value of the duplicate data b between the moved third portion and second portion.

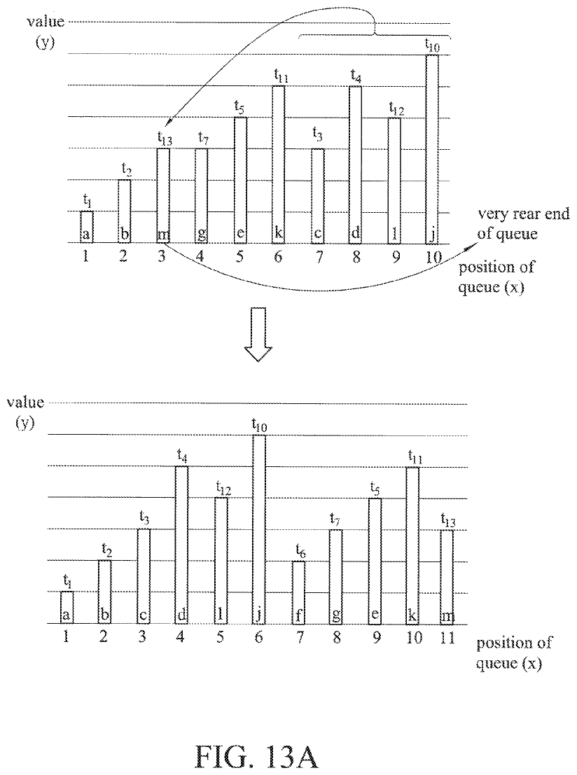

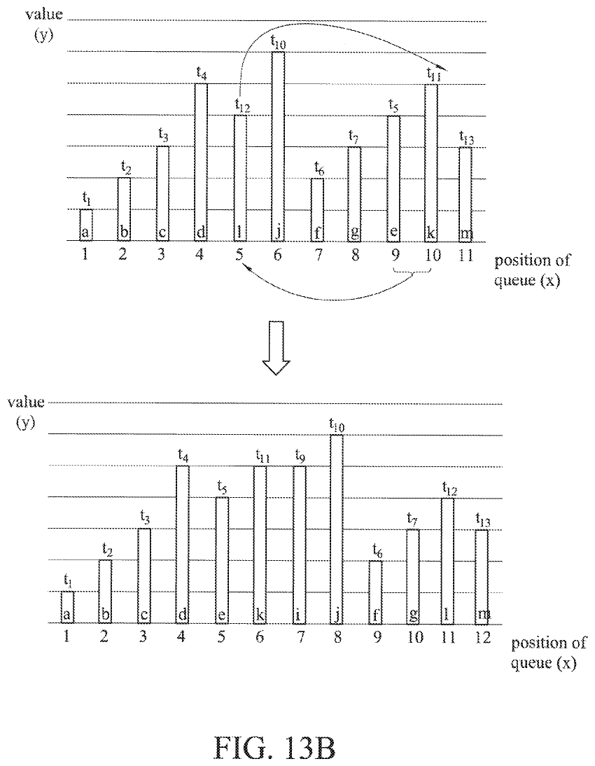

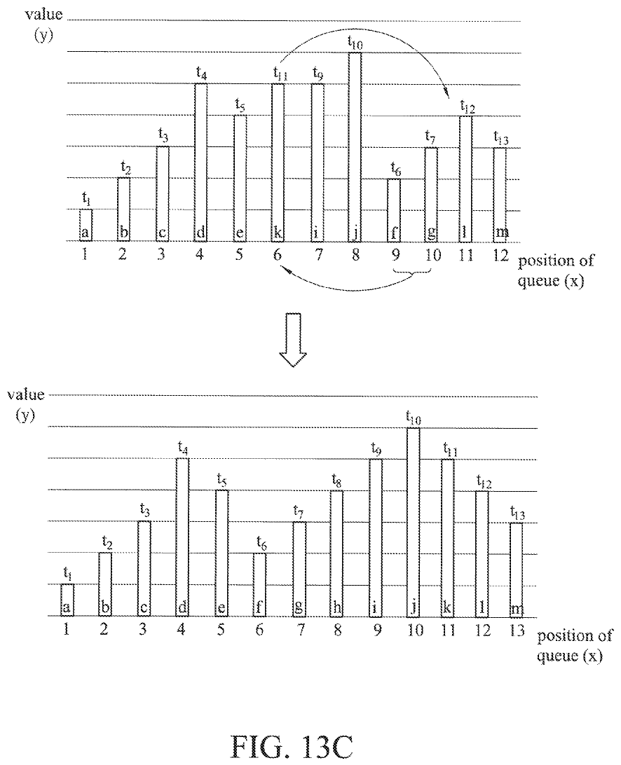

FIG. 13A to FIG. 13C are schematic diagrams of a data restoring algorithm restoring data of a queue according to an embodiment of the present disclosure, used to restore the data below the embodiment of FIG. 10C (another type of the data reduction algorithm).

As shown in the embodiment of FIG. 13A, the data restorer determines whether multiple pieces of data are sorted based on the timestamps. If not (the data are not sorted based on the timestamps), the data restorer restores the data by the data restoring algorithm. If so (the data have been sorted based on the timestamps), the data restorer does not need to restore the data.

When the data are not sorted based on the timestamps, the data restorer finds the data m with the latest timestamps t₁₃, and the data m is not at the very rear end of the queue (a position 3 of the queue). Next, the data restorer fills a position 2 to a position 7 with a value of the position 2 (data b), finds the data c (timestamps t₃) after the position 2 (data b) and closest to the position 2 (data b), and inserts all data c (timestamps t₃) and the subsequent data (data d, 1 and j) forward from the position 3 and timestamps t₁₃. Then, the data restorer fills the position of the original timestamps t₁₃ with the value of the position 2(data b), and moves the data m of the timestamps t₁₃ to the last end of the queue, and the data m is no longer involves in the subsequent operations.

As shown in the embodiment of FIG. 13B, the data restorer finds the data l that is not processed and is the latest timestamps t₁₂, and the data l is not at the last end of the queue (at a position 5 of the queue). Then, the data restorer fills the position 4 to the position 10 with the value of the position 4 (data b), finds the data e (timestamp t₅) after the position 4 (data d) and closest to the position 4 (data d), inserts all the data e of timestamps t₅ and the data k thereafter (excluding the processed data m that has been moved backwards) into the position 5, and moves the data l of the timestamps t₁₂ to a position before the data m at the latest end of the queue, and the data l is no longer involved in the subsequent operations.

As shown in the embodiment of FIG. 13C, the data restorer finds the data k that is unprocessed and is the latest timestamps t₁₁, and data k is not at the last end of the queue (at a position 6 of the queue). Next, the data restorer fills the position 6 to the position 8 with the value of the position 5 (data e), finds the data f (timestamp t₆) after the position 5 (data e) and closest to the position 5 (data e), inserts all the data f of the timestamps t₆ and the data g thereafter (excluding the processed data l and m that have been moved backwards) into the positions 6 and 7, and moves the data k of the timestamps t₁₁ to a position before the data l and mat the last end of the queue, and the data k is no longer involved in the subsequent operations.

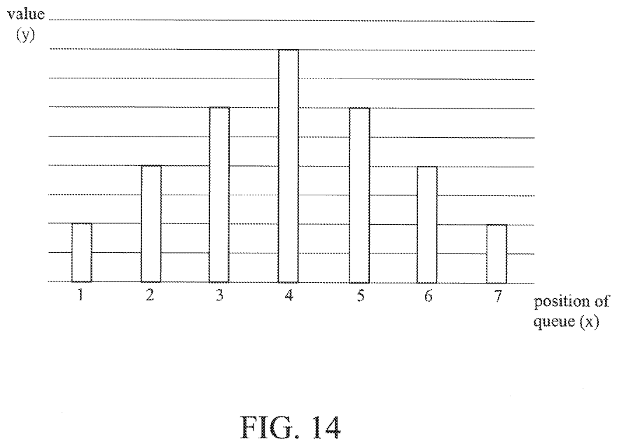

FIG. 14 is a schematic diagram of the best circumstance of data of a queue according to the present disclosure. When the corresponding queue of the monitoring unit has sufficient borrowing space, the queue space adjustment algorithm (i.e., the dynamic queue space adjustment algorithm) of the queue space adjuster can completely maintain the data without distortion. Meanwhile, as shown in the embodiment of FIG. 14, the data, when the data constitutes a symmetric bell-shape distribution, it is the most ideal condition, and the second type using the data reduction algorithm can accommodate (n−1)/2 data and maintain the data without distortion or low distortion.

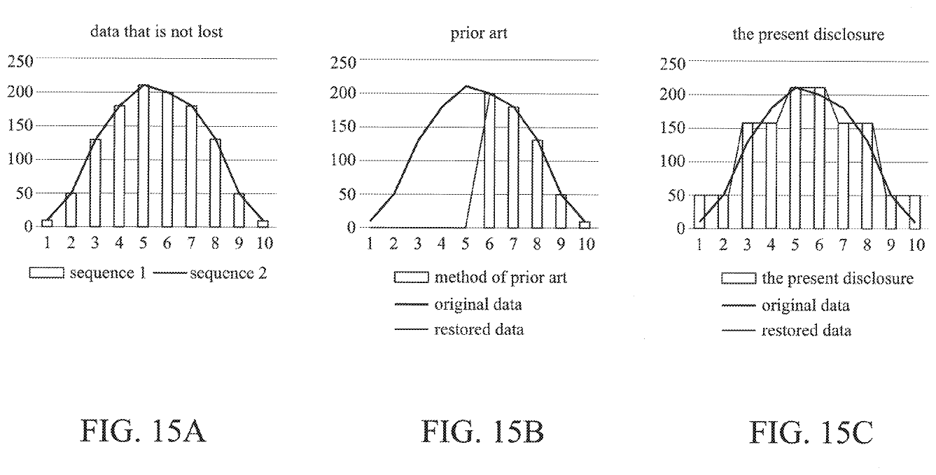

FIG. 15A is a schematic diagram showing a result of a state that data is not lost according to an embodiment of the present disclosure. FIG. 15B is a schematic diagram showing a result of a resource adjusting and controlling method according to the prior art. FIG. 15C is a schematic diagram showing a result of a server and a resource adjusting and controlling method according to an embodiment of the present disclosure.

As shown in the drawings, compared with the data of FIG. 15A without loss of state, FIG. 15B shows that a resource adjusting and controlling method according to the prior art is likely to cause a high distortion of data in an (OPC UA) industrial transmission system, but FIG. 15C shows that a server and a resource adjusting and controlling method according to the present disclosure can achieve the adjusting and controlling effect of low distortion of data.

As can be seen from the above, the present disclosure uses a Resources Assignment & Regulation Method (RAR) to operate a queue space adjusting algorithm to adjust the dynamic resources, allocate the space sizes of the queues of different monitoring tags in a limited queue space (hardware resources), retain the important off-peak values of the data and reduce the distortion of the data by the data reduction algorithm. Moreover, the present disclosure effectively allocates and adjusts hardware resources by monitoring the usage rate of the space of each of the monitoring tags, and improves a number of the monitoring tags that are to be monitored. At the same time, the present disclosure uses the data reduction algorithm (or a data screening method) to retain important data and reduce the degree of data distortion, to facilitate the accuracy of data statistics.

In addition, in the application of industrial networks, the present disclosure can increase a number of monitoring tags that a server monitors by more than 30%. For instance, a basic OPC UA server can simultaneously monitor information on 100 monitoring tags, while the present disclosure can monitor at least 130 tags, without increasing an additional cost. Moreover, in the monitoring of the wireless network, the present disclosure can reduce the transmission amount of network packets, and save the battery consumption of equipment. For instance, the present disclosure can send the information of the packets every 10 seconds, and through the present disclosure, more information can be stuffed into the packets, thereby extending the transmission time to save power of the equipment.

It will be cleared to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A server, comprising:
a plurality of queues, each of which having its respective queue size; and
one or more processors executing a plurality of instructions to perform a resource adjusting and controlling process, including actuating:
a plurality of monitoring units, each of which monitoring one of a plurality of monitoring tags and corresponding to one of the plurality of queues, wherein each of the plurality of queues is configured for storing data of the plurality of monitoring tags and timestamps of the data;
a resource monitoring device configured for monitoring usage statuses of the plurality of queues corresponding to the plurality of monitoring units and determining if one of the monitoring units performs a queue space adjustment based on the usage statuses when new data of the monitored monitoring tags is obtained, wherein the one of the plurality of monitoring units adds the obtained new data to a corresponding one of the queues if the queue space adjustment is not performed;
a queue space adjuster configured for determining whether there is a sufficient space for the queue space adjustment, wherein if the queue space adjustment is performed and one or more of the plurality of queues has a space that is adjustable, the space of the one or more of the plurality of queues is adjusted to enable the obtained new data to be added to the adjusted one or more of the plurality of queues; and
a data reducer configured for reducing data stored in the corresponding one of the queues of the one of the plurality of monitoring units, if the queue space adjustment is performed and no space in the plurality of queues is adjustable, based on the timestamps of the data stored in the corresponding one of the queues and a position of the data stored in the corresponding one of the queues to enable the obtained new data to be added to the corresponding one of the queues.

2. The server of claim 1, wherein the plurality of monitoring units monitor the plurality of monitoring tags correspondingly to transmit data obtained from the plurality of monitoring tags.

3. The server of claim 1, further comprising a storing device having the plurality of queues storing the plurality of instructions executed by the one or more processors and parameters of the plurality of queues corresponding to the plurality of monitoring units.

4. The server of claim 1, wherein by operating a queue space adjusting algorithm, the queue space adjuster determines whether one or more of the plurality of queues have a space for adjustment based on parameters of the one or more of the plurality of queues to adjust the space of the one or more of the plurality of queues dynamically, wherein the parameters of the one or more of the plurality of queues comprise at least one of a sampling frequency, a queue size and an issuing time to perform the queue space adjustment.

5. The server of claim 4, wherein the queue space adjuster further determines whether each space in the plurality of queues corresponding to the one or more of the plurality of monitoring units is borrowed based on the parameters of the plurality of queues, a remaining time of the plurality of queues from the issuing time, and a space of the queues that has been used, to perform the queue space adjustment dynamically.

6. The server of claim 4, wherein the queue space adjuster further performs:
calculating each borrowable space in the plurality of queues based on the obtained new data and selecting a single queue having a smallest amount of the borrowable space to borrow space; and
determining whether to borrow space in the plurality of queues corresponding to a plurality of monitoring units if the single queue is not found, and selecting multiple monitoring units with a largest amount of borrowable space to borrow if a total amount of space that is borrowed by the plurality of monitoring units is greater than a demand space.

7. The server of claim 6, wherein if the single queue is not found, the queue space adjuster starts to borrow from the queue that has the largest amount of the borrowable space until an accumulated space of the plurality of queues is borrowed to a sufficient space.

8. The server of claim 1, wherein the data reducer is based on a data reduction algorithm to reduce the data of the corresponding one of the queues of the one of the plurality of monitoring units, and performs:
obtaining a pair of data with a smallest difference in data values in the space of the corresponding one of the queues that needs to be adjusted; and
when the pair of data is adjacent in the corresponding one of the queues, removing the data with a larger timestamp in the pair of data from the corresponding one of the queues by the data reducer to move all data except the position of the data forward by one queue position, and storing the obtained new data in the queue position behind all the data in the corresponding one of the queues.

9. The server of claim 8, wherein the data reduction algorithm of the data reducer further comprises:
when the pair of data is not adjacent in the corresponding one of the queues of the one of the plurality of monitoring units and the timestamp of the pair of data in which the timestamp is smaller than the pair of data is greater than and closest to the data with the smaller timestamp in the pair of data, removing the data with a larger timestamp in the pair of data by the data reducer, moving all the data in the middle of the pair of data back one queue position, and storing the obtained new data in the queue position where the data is removed, or removing the data with the smaller timestamp in the pair of data.

10. The server of claim 1, further comprising a data restorer restoring the data of the corresponding one of the queues of the one of the plurality of monitoring units based on a data restoring algorithm, wherein the data restoring algorithm comprises: obtaining the data of the corresponding one of the queues by the data restorer, determining that the data of the corresponding one of the queues is the data that has been restored or do not need to be restored by the data restorer when the data of the corresponding one of the queues are sorted according to their respective timestamps, and restoring the data of the corresponding one of the queues through the timestamps of the data of the corresponding one of the queues and a relative sorting position of the data in the corresponding one of the queues by the data restorer when the data of the corresponding one of the queues are not sorted according to the respective timestamps.

11. A resource adjusting and controlling method, comprising:
monitoring, by a plurality of monitoring units of a server, one of a plurality of monitoring tags, wherein each of the plurality of monitoring units corresponds to one of a plurality of queues, and wherein each of the plurality of queues is used for storing data of the plurality of monitoring tags and timestamps of the data, and each of the plurality of queues has its respective queue size;
monitoring, by the server, usage statuses of the plurality of queues corresponding to the plurality of monitoring units, and determining if one of the monitoring units performs a queue space adjustment based on the usage statuses when new data of the monitored monitoring tags is obtained;
adding the obtained new data to a corresponding one of the queues of the one of the plurality of monitoring units by the server if the queue space adjustment is not performed;
adjusting space of the one or more of the plurality of queues if the queue space adjustment is performed and one or more of the plurality of queues have a space that is adjustable to enable the obtained new data to be added to the adjusted one or more of the plurality of queues; and
reducing data stored in the corresponding one of the queues of the one of the plurality of monitoring units, if the queue space adjustment is performed and no space in the plurality of queues is adjustable, based on the timestamps of the data stored in the corresponding one of the queues and a position of the data stored in the corresponding one of the queues to enable the obtained new data to be added to the corresponding one of the queues.

12. The resource adjusting and controlling method of claim 11, wherein the plurality of monitoring units monitor the plurality of monitoring tags correspondingly to transmit data obtained from the plurality of monitoring tags.

13. The resource adjusting and controlling method of claim 11, wherein operating a queue space adjusting algorithm by the server, the queue space adjusting algorithm comprises: determining whether the one or more of the plurality of queues have a space for adjustment based on parameters of the one or more of the plurality of queues to adjust the space of the one or more of the plurality of queues dynamically, wherein the parameters of the one or more of the plurality of queues comprise at least one of a sampling frequency, a queue size and an issuing time to perform the queue space adjustment.

14. The resource adjusting and controlling method of claim 13, wherein the queue space adjusting algorithm further comprises: determining whether each space in the plurality of queues corresponding to the one or more of the plurality of monitoring units is borrowed based on the parameters of the plurality of queues, a remaining time of the plurality of queues from the issuing time, and the space of the queues that have been used, to perform the queue space adjustment dynamically.

15. The resource adjusting and controlling method of claim 13, wherein the queue space adjusting algorithm further comprises:
calculating each borrowable space in the plurality of queues based on the obtained new data and selecting a single queue having a smallest amount of the borrowable space to borrow; and
determining whether to borrow space in the plurality of queues corresponding to a plurality of monitoring units if the single queue is not found, and selecting multiple monitoring units with a largest amount of borrowable space to borrow if a total amount of space that is borrowed by the plurality of monitoring units is greater than a demand space.

16. The resource adjusting and controlling method of claim 15, wherein if the single queue is not found, the server starts to borrow from the queue that has the largest amount of the borrowable space until an accumulated space of the plurality of queues is borrowed to a sufficient space.

17. The resource adjusting and controlling method of claim 11, wherein the server is based on a data reduction algorithm to reduce the data of one of the plurality of queues of the one of the plurality of monitoring units, and the data reduction algorithm comprises:
obtaining a pair of data with a smallest difference in the space corresponding to the corresponding one of the queues that needs to be adjusted; and
when the pair of data is adjacent in the corresponding one of the queues, removing data with a larger timestamp in the pair of data from the corresponding one of the queues by the server to move all data except the position of the data forward by one queue position and storing the obtained new data in the queue position behind all the data in the corresponding one of the queues.

18. The resource adjusting and controlling method of claim 17, wherein the data reduction algorithm further comprises:
when the pair of data is not adjacent in the corresponding one of the queues of the one of the monitoring units and the timestamp of the pair of data in which the timestamp is smaller than the pair of data is greater than and closest to the data with the smaller timestamp in the pair of data, removing the data with a larger timestamp in the pair of data by the server, moving all the data in the middle of the pair of data back one queue position, and storing the obtained new data in the queue position where the data is removed, or removing the data with the smaller timestamp in the pair of data by the data reducer.

19. The resource adjusting and controlling method of claim 11, further comprising restoring the data of the corresponding one of the queues of the one of the monitoring units based on a data restoring algorithm, the data restoring algorithm comprising: obtaining the data of the corresponding one of the queues by the server, determining that the data of the corresponding one of the queues is the data that have been restored or do not need to be restored by the server when the data of the corresponding one of the queues are sorted based on their respective timestamps, and restoring the data of the corresponding one of the queues through the timestamps of the data of the corresponding one of the queues and a relative sorting position of the data in the corresponding one of the queues by the server when the data of the corresponding one of the queues are not sorted based on the respective timestamps.
